(19) United States
(12) Patent Application Publication
(10) Pub. No.: US 2010/0086900 A1
(43) Pub. Date: Apr. 8, 2010

(54) COPING-ANALOGUE KIT

(75) Inventor: Dale Whipple, East Taunton, MA (US)

Correspondence Address: BANNER & WITCOFF, LTD., TEN SOUTH WACKER DRIVE, SUITE 3000, CHICAGO, IL, 60606, US

(73) Assignee: Keystone Dental, Inc., Burlington, MA (US)

(21) Appl. No.: 12/436,605

(22) Filed: May 6, 2009

Related U.S. Application Data
(60) Provisional application No. 61/050,704, filed on May 6, 2008.

(51) Int. Cl. A61C 8/00

(52) U.S. Cl. 433/201.1

(57) ABSTRACT

Disclosed is a kit useful in connection with the preparation of dental prostheses and including an implant-abutment analogue and a burnout coping. The analogue generally corresponds to an implant and abutment in the jaw of a patient. A burnout coping is secured to the analogue for the preparation of the dental prosthetic. In one embodiment, the analogue includes a connection feature and the coping includes a mating connection feature, the connection feature on the coping positioned to provide a remnant on the dental prosthetic prepared thereform that does not interfere with the placement of the prosthetic onto an implant and abutment in the jaw of a patient. In another embodiment, not mutually exclusive with respect to the first embodiment, the coping comprises first and second portions that are movable with respect to one another and sized respectively to engage first and second portions of an analogue.

### RELATED APPLICATION

This application claims the benefit of prior U.S. Patent Application Ser. No. 61/050,704, filed May 6, 2008, the entire disclosure of which is hereby incorporated by reference.

### FIELD OF THE INVENTION

The invention is in the field of prosthetic dentistry. More specifically, the invention is in the field of formation of dental prostheses.

### BACKGROUND OF THE INVENTION

Dental implants and methods for preparing dental prostheses long have been known in the art. A dental implant is effectively a socket that is set into the jaw of a patient in accordance with known techniques. Upon osseointegration of the implant, the implant forms a false root for superseding prosthetic structures. Dental implants typically are provided with internal threads onto which other structures, such as dental abutments and ultimately prostheses, are affixed.

In the preparation of a prosthesis, it is necessary to take into account the position of the implant in the jaw and the surrounding natural or prosthetic teeth. In one typical operation, after the implant has osseointegrated, a position impression cap is affixed to the implant, and an impression forming material is introduced in the region of the implant. Most typically, an abutment is temporarily placed into position before affixing the impression cap. The impression material is typically an epoxy or putty material that will harden to form a negative impression of the implant and abutment and surrounding dental structures. The impression material is then removed from the oral cavity, carrying with it the impression cap, and this combination is sent to a laboratory for fabrication of the prosthesis.

At this point, an implant-abutment analogue is inserted onto the impression cap. The analogue is of the general shape and configuration of the implant and abutment that were present in the jaw of the patient upon taking the impression. The negative impression is then filled with a plaster material, which also covers the base of the analogue. Upon hardening of the plaster and removal of the impression material, a positive impression of the patient's oral cavity is created, with the implant analogue set in the plaster and properly positioned and oriented to replicate the position of the implant and abutment in the patient's jaw.

At this point, a burnout coping is affixed to the analogue. The burnout coping is a generally cone-shaped plastic structure that is intended to engage the analogue and to serve as a base for further preparation of the prosthetic, typically by “waxing-up” a tooth or series of teeth. The burnout coping then is removed along with the wax prosthetic. This structure will have the final shape and orientation of the dental prosthesis. Using an investment casting process, the final prosthetic is prepared therefrom. Desirably, the final prosthetic will fit into place very precisely on the positive impression and ultimately will fit precisely in the jaw of the patient. In the investment casting process, both the wax and the material of the burnout coping are lost and replaced with the prosthetic material.

In some conventional processes, the burnout coping is affixed to the analogue using a connection feature that engages a portion of the analogue. Generally, the prosthesis prepared therefrom will have a remnant in this region that closely approximates the connection feature of the burnout coping. The remnant generally is not needed in the final prosthetic, which will be secured to the abutment in the patient's jaw using a mechanical connection and/or a bonding agent. In prior known embodiments, this connection feature may interfere with the placement of the prosthesis onto the abutment and analogue in the jaw of the patient, and hence must be removed by milling or other techniques. In some cases, this can lead to the introduction of deformations in the prosthesis or inaccurate fitting of the prosthesis onto the implant and abutment.

### SUMMARY

The invention provides various embodiments of kits, implant-abutment analogues, burnout copings, and methods. In one embodiment, a kit includes an implant-abutment analogue and a burnout coping engageable with the analogue. The analogue includes an analogue connection feature that is engageable with the burnout coping connection feature on the burnout coping. The burnout coping connection feature is positioned to provide a connection feature remnant on a dental prosthetic prepared therefrom that does not interfere with the placement of the dental prosthetic onto the corresponding implant and abutment. In one embodiment, the implant comprises a boss that is disposed on a portion of the analogue that corresponds to a void space on the corresponding implant and abutment. The coping is formed of a material that is sufficiently elastomeric to provide a retention press fit on the boss. In another embodiment, not mutually exclusive with respect to the first embodiment, a burnout coping comprises a first portion and a second portion, the second portion being movable with respect to the first portion. The first portion is sized to engage a first portion of the analogue and the second portion is sized to engage a second portion of the analogue. A method of preparing a dental prosthesis using the implant-abutment analogue and burnout coping thus described also is provided. Except in the configuration and manipulation of the analogue and coping, the method otherwise may be conventional or as otherwise found to be suitable.

### DETAILED DESCRIPTION OF THE FIGURES

FIG. 1 is a perspective view of a dental implant.

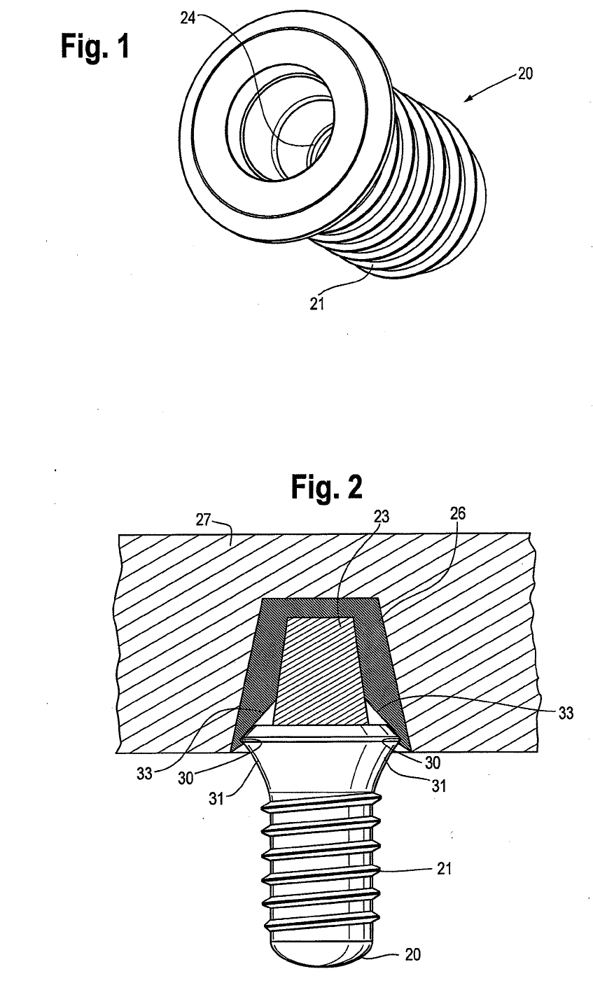

FIG. 2 is a side elevation, enlarged with respect to FIG. 1, and partially cut away, of the dental implant shown in FIG. 1 including an abutment and impression cap used during the taking of a dental impression.

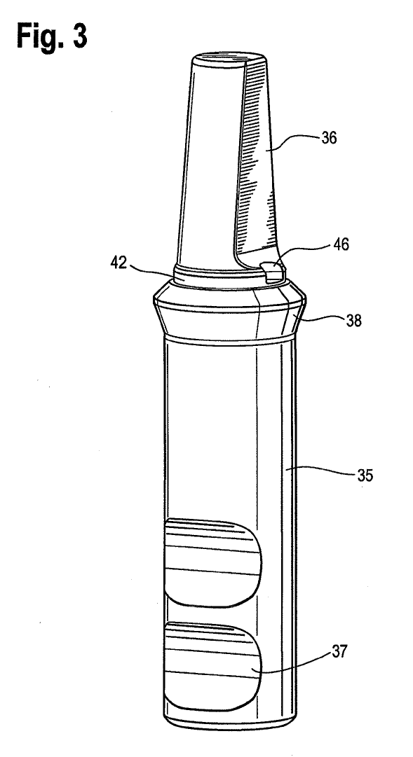

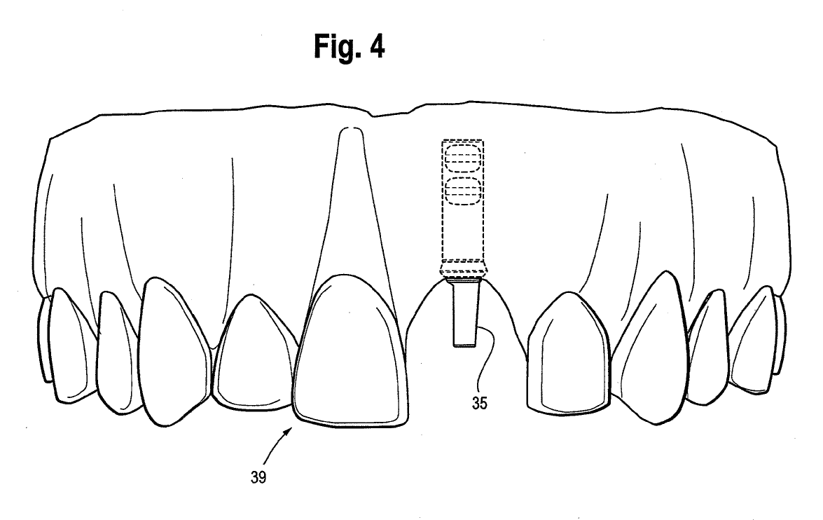

FIG. 3 is a perspective view of an analogue.

FIG. 4 is a perspective view of a positive impression, the positive impression including the analogue illustrated in FIG. 3 and formed after the negative impression operation illustrated in FIG. 1.

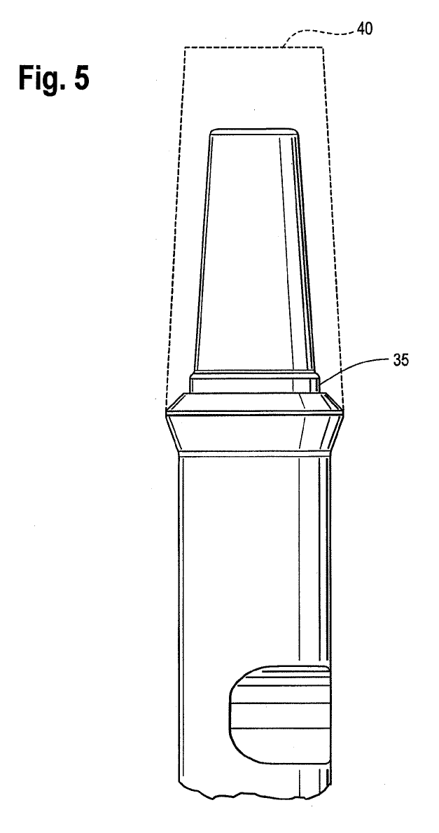

FIG. 5 is a side elevation of the analogue illustrated in FIG. 3 and further illustrating a burnout coping connected thereto.

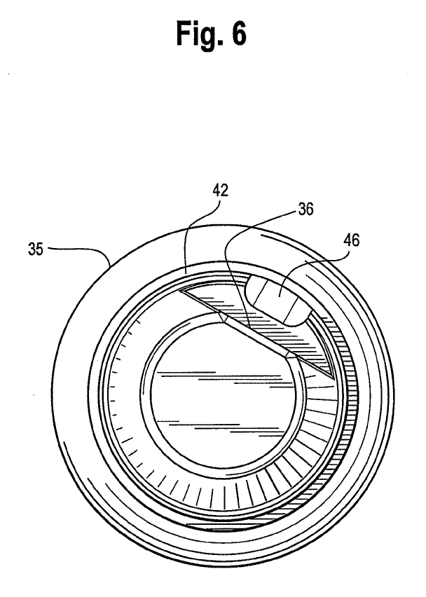

FIG. 6 is a top view of the analogue illustrated in FIG. 3.

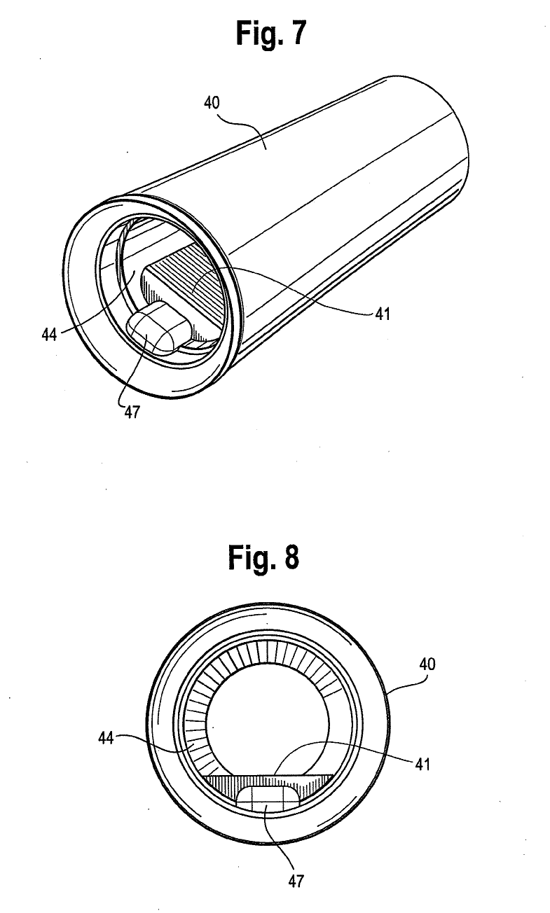

FIG. 7 is a perspective view of the coping shown in FIG. 5.

FIG. 8 is a bottom view of the coping illustrated in FIG. 7.

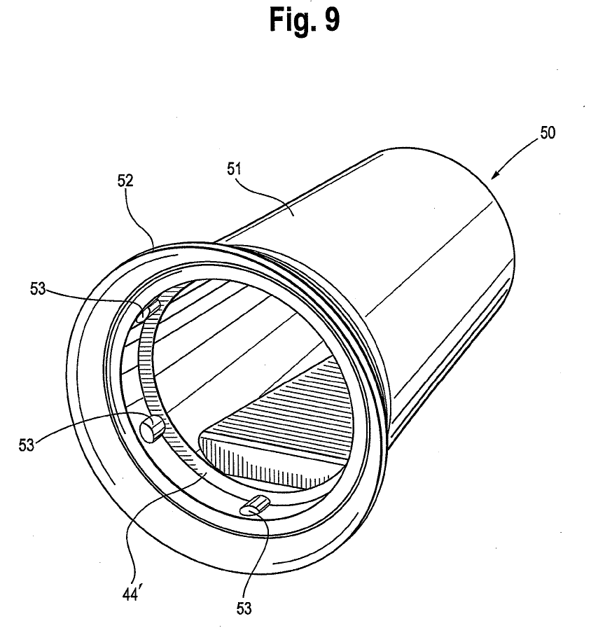

FIG. 9 is a perspective view of an alternative two-part coping.

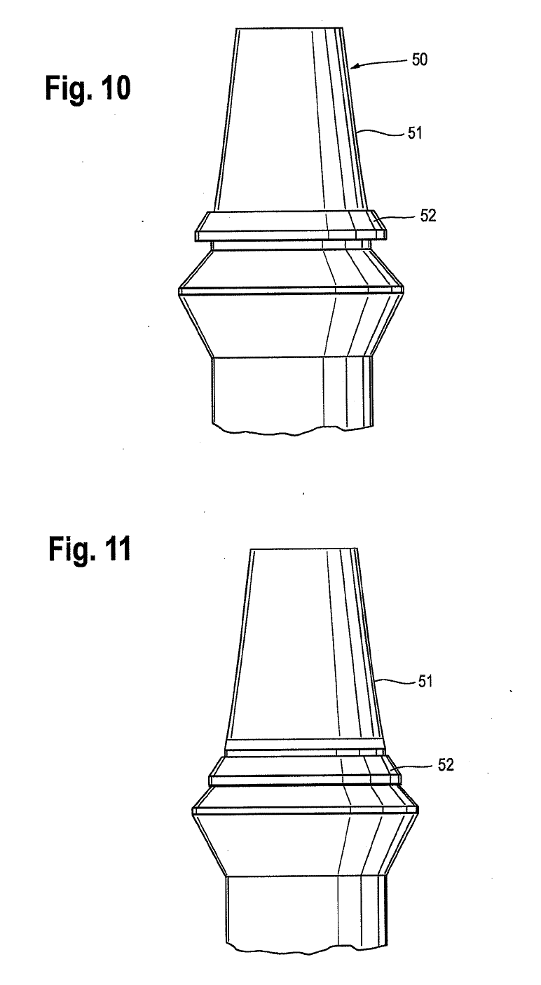

FIG. 10 is a perspective view of the two-part coping illustrated in FIG. 10, illustrating placement of the coping onto an analogue with the first part seated on the analogue but the second part not yet seated on the analogue.

FIG. 11 is a view similar to FIG. 10, but illustrating both the first and second coping parts seated on the analogue.

It should be understood that terms such as “top,” “front” and other terms of orientation are used relative to the drawings themselves and not necessarily to the orientation of the various illustrated parts in use. In use, the parts may be oriented in many directions. The drawings are not intended necessarily to represent scale drawings.

### DETAILED DESCRIPTION

As illustrated in FIG. 1, the dental implant 20 is essentially a socket that includes threads 21 disposed on the exterior surface and internal threads 24. In use, as it is conventionally known, the implant is inserted into the jaw of the patient, whereupon, with time, the implant will osseointegrate and form a unitary structure with the patient's jaw. The internal threads 24 are used to support an abutment and superseding prostheses such as false teeth and bridges. Numerous dental implants and implant configurations are known in the field, and the invention is not limited to the implant shown in FIG. 1

After placement of the implant (and generally after osseointegration), an abutment 23 is affixed temporarily to the implant for taking of an impression. As shown in FIG. 2, to take a dental impression an impression cap 26 is affixed to the implant 20, and a putty material 27 is introduced into the region of the implant and surrounding dental structures. In the illustrated embodiment, the impression cap 26 is fitted with an undercut portion 30 that engages a side surface 31 on the implant. Other configurations for the impression cap are possible. As seen in the cutaway portion, the impression cap leaves a void space 33 at the interface between the implant 30 and abutment 23.

Upon removable of the impression material from the jaw of the patient, a negative impression will be formed. The impression cap 26 will be carried away with the impression material. Subsequently, an implant analogue 35, as shown in FIG. 3, is affixed to the impression cap 26. The analogue 35 has an indexing wall surface 36 that corresponds to a similar indexing surface (not shown) on the abutment. A molding material, typically plaster, is introduced to the negative impression and surrounds the base 37 of the analogue 35. It should be noted that the base 37 does not necessarily correspond to the threaded portion of the dental implant; rather, it is sufficient that the head portion 38 of the analogue corresponds to the head portion of the implant. Upon setting of the plaster material, a positive impression 39 (shown in FIG. 4) of the patient's jaw will be provided, the positive impression including the analogue 35 properly positioned and oriented with respect to the ultimate position of the implant and abutment in the patient's jaw.

Subsequently, a burnout coping 40, such as that illustrated in FIG. 5 (shown in phantom), is affixed thereto. In the illustrated embodiment and with further reference to FIGS. 7-8, it is seen that the coping 40 includes an inner indexing wall 41 that corresponds with the indexing wall surface 36 of the analogue. Additionally, in the illustrated embodiment, it is seen that the analogue 35 includes a boss 42 disposed on a surface thereof This boss engages a surface 44 of the coping 40 to enable a retention press fit thereon. The exact nature of the fit is not critical so long as the burnout coping can be retained on the boss in a manner to permit the performance of subsequent steps.

The indexing wall surface 41 of the coping in engagement with the indexing wall 36 of the analogue is sufficient to align the coping and analogue rotationally. For further accuracy and with reference to FIGS. 6 and 7, the boss 42 is provided with a socket 46 that engages a protrusion 47 in the coping. In the illustrated embodiment, a single socket is shown, but a greater number could be employed to correspond with a similar number of protrusions on the coping.

As seen, the coping is not provided with an undercut surface in the illustrated embodiment, but rather the surface 44 serves as a connecting feature that engages the boss 42 which serves as the analogue connecting feature. The connecting features meet and are engaged in a position that, upon final preparation of the prosthesis, will not interfere with the fit of the prosthesis onto the implant and abutment in the jaw of the patient. It is noted that the boss 42 is disposed in a void space of the implant and abutment i.e., a space that will tolerate the connecting feature remnant when the prosthesis is affixed to the implant and abutment in the patient.

In some embodiments, not necessarily coextensive with the heretofore described embodiments but not mutually exclusive therewith, a two-part coping is provided. As seen in FIG. 9, the two-part coping 50 includes a first part 51 and a second part 52 that is movable with respect to the first part. When used with the heretofore described analogue, the connecting feature is a surface 44′ that is included on the first part 51 of the coping 50. The illustrated coping includes six bosses (three of which are visible at 53) for mating with six sockets (not shown) on a corresponding analogue. In use, as illustrated in FIGS. 10 and 11, first the first of the two parts is affixed to the analogue 35 by fitting the connecting surface 44′ onto the boss. Subsequently, the second part 52 is moved with respect to the first part 51 to engage a second part of the analogue 35. It is contemplated that the provision of such coping will improve the accuracy of the process of formation of the final prosthetic.

The remainder of the formation of the prosthesis may be conventional. In accordance with known methods, a prosthetic may be formed on the surface of a burnout coping using conventional wax or other materials. In the loss-wax investment casting process, in which both the burnout coping and wax are sacrificed, a dental prosthesis may be prepared therefrom. It is contemplated that other methods of formation of a dental prosthesis may be employed in connection with the foregoing teachings. Likewise, it is contemplated that the prosthesis may be a single tooth or a more complicated structure such as a series of teeth.

When a dental prosthetic is prepared in accordance with these teachings, the remnant of the connecting surface and indexing protrusions can be made to be disposed in the void space of the implant and abutment. These features need not be removed by milling prior to installation of the prosthesis.

It is thus seen that, in some embodiments, a prosthesis may be provided in which the connecting feature need not be removed prior to use. Generally, the analogue and coping will be provided together in the form of a kit, the kit optionally being provided with other components useful in the fabrication of prostheses.

Any description of certain embodiments as “preferred” embodiments, and other recitation of embodiments, features, or ranges as being preferred, is not deemed to be limiting, and the invention is deemed to encompass embodiments that are presently deemed to be less preferred. All methods described herein can be performed in any suitable order unless otherwise indicated herein or otherwise clearly contradicted by context. The use of any and all examples, or exemplary language (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context.

What is claimed is:

1. A kit comprising:
an implant-abutment analogue, said implant-abutment analogue representing a corresponding dental implant and abutment; and
a burnout coping engageable with said analogue, said analogue including an analogue connection feature engageable with a burnout coping connection feature on said burnout coping, said burnout coping connection feature positioned to provide a connection feature remnant on a dental prosthetic prepared therefrom that does not interfere with the placement of the dental prosthetic onto the corresponding implant and abutment.

2. A kit according to claim 1, said analogue comprising a boss disposed on a portion of said analogue that corresponds to a void space on the corresponding implant and abutment, said coping being formed of a material that is sufficiently elastomeric to provide a retention press fit on said boss.

3. A kit according to claim 1, said analogue having an indexing wall surface and said coping having a corresponding indexing wall surface.

4. A kit according to claim 3, said analogue comprising a boss disposed on a portion of said analogue that corresponds to a void space on the corresponding implant and abutment, said coping being formed of a material that is sufficiently elastomeric to provide a retention press fit on said boss, said boss having an alignment socket and said coping having a corresponding alignment protrusion.

5. A kit according to claim 4, said boss including plural alignment sockets and said coping including plural corresponding alignment protrusions.

6. A kit according to claim 1, said coping comprising first and second parts movable with respect to each other, said first part including said burnout coping connecting feature and being sized to engage the analogue connection feature and said second part movable with respect to said first part and sized to engage a different portion of said analogue.

7. A method for preparing a dental prosthesis, comprising:
providing a dental impression including an impression cap that corresponds to the position of an implant and abutment in the jaw of a patient;
securing an implant-abutment analogue to said impression to form a negative impression combination;
forming a positive impression from said negative impression combination;
securing a burnout coping to said analogue to form a positive impression combination; and
forming a prosthesis using said positive impression combination, said coping being secured to said analogue via mating connection features, said analogue including an analogue connection feature engageable with a burnout coping connection feature on said burnout coping, said burnout coping connection feature positioned to provide a connection feature remnant on a dental prosthetic prepared therefrom that does not interfere with the placement of the dental prosthetic onto the corresponding implant and abutment.

8. A method according to claim 7, said analogue comprising a boss disposed on a portion of said analogue that corresponds to a void space on the corresponding implant and abutment, said coping being formed of a material that is sufficiently elastomeric to provide a retention press fit on said boss.

9. A method according to claim 7, said analogue having an indexing wall surface and said coping having a corresponding wall surface.

10. A method according to claim 7, said analogue comprising a boss disposed on a portion of said analogue that corresponds to a void space on the corresponding implant and abutment, said coping being formed of a material that is sufficiently elastomeric to provide a retention press fit on said boss, said boss having an alignment socket and said coping having a corresponding alignment protrusion.

11. A method according to claim 10, said boss including plural alignment sockets and said coping including plural corresponding alignment protrusions.

12. A method according to claim 7, said coping comprising first and second parts movable with respect to each other, said first part including said burnout coping connection feature and being sized to engage said analogue connection feature and said second part movable with respect to said first part and sized to engage a different portion of said analogue.

13. A kit comprising an implant-abutment analogue and a burnout coping, said burnout coping comprising a first portion and a second portion movable with respect to said first portion, said first portion sized to engage a first portion of said analogue and said second portion sized to engage a second portion of said analogue.
